(19) United States
(12) Patent Application Publication
(10) Pub. No.: US 2023/0122719 A1
(43) Pub. Date: Apr. 20, 2023

(54) MEMORY ACCESSES

(71) Applicant: Hewlett-Packard Development Company, L.P., Spring, TX (US)

(72) Inventors: Chia-Cheng Lin, New Taipei City (TW); Thong Thai, Houston, TX (US); Hsin-Jen Lin, New Taipei City (TW); Super Liao, Hsinchu (TW)

(21) Appl. No.: 17/503,021

(22) Filed: Oct. 15, 2021

(51) Int. Cl. G06F 3/147; G06F 13/42

(52) U.S. Cl. CPC G06F 3/147; G06F 13/4282

(57) ABSTRACT

In some examples, a method includes receiving, by a timing controller of a display device, an indication from an embedded controller of a computing device during a computing device startup procedure. In some examples, the method includes determining, by the timing controller, whether to access display image memory or computing device image memory based on the indication. In some examples, the method includes accessing, by the display device, the computing device image memory in response to determining to access the computing device image memory. In some examples, the method includes causing the display device to display an image from the computing device image memory in response to determining to access the computing device image memory.

### BACKGROUND

Some electronic devices include electronic circuitry for performing processing. As processing capabilities have expanded, electronic devices have been utilized to perform more functions. For example, a variety of electronic devices are used for work, communication, and entertainment. Electronic devices may be linked to other devices and may communicate with other devices.

### BRIEF DESCRIPTION OF THE DRAWINGS

FIG. 1 is a flow diagram illustrating an example of a method for memory access;

FIG. 2 is a block diagram of an example of a display device that may be used to perform memory access;

FIG. 3 is a block diagram of an example of a display device that may be used to perform memory access; and

FIG. 4 is a block diagram illustrating an example of a computer-readable medium for memory access.

### DETAILED DESCRIPTION

A display device is an electronic device to display images (e.g., video). Examples of display devices include monitors, laptop hinge-up displays, televisions, touchscreens, computer screens, etc. A display device may include a timing controller. A timing controller is a circuit that maps image data (e.g., frame data) to display locations (e.g., cells, pixels, rows, columns, panel addresses, etc.). A timing controller may receive image data from another circuit (e.g., graphics processing unit (GPU), memory, etc.). In some examples, the timing controller 204 may be a microcontroller unit (MCU), application-specific integrated circuit (ASIC), and/or other circuitry.

In some approaches, a timing controller may be utilized to support displaying an image (e.g., startup image, logo, etc.) from memory included in a display device and/or on a timing controller board. For instance, image data representing an image may be stored in memory on the display device and may be displayed when display device backlight control signals are ready. The memory capacity on the display device may be relatively small, which may limit the quantity and/or quality (e.g., resolution, color depth, etc.) of an image(s) stored in the memory on the display device.

Some examples of the techniques described herein may expand a capacity to display an image or images (e.g., animations, video, etc.) on a display device during a startup procedure (e.g., during bootup, resuming operation from hibernation mode and/or sleep mode, etc.). For instance, higher capacity memory may be located on a motherboard of a computing device. In some examples, a timing controller on a display device may access the externally-located higher-capacity memory to obtain an image or images. For instance, a timing controller may access external Electrically Erasable Programmable Read-Only Memory (EEPROM) via a Serial Peripheral Interface (SPI) and/or an Inter-Integrated Circuit (I2C or I2C BUS®) interface. Higher-capacity memory may be utilized to store more and/or higher quality image(s).

In some examples, an image or images stored on externally located memory may be utilized to identify a status (e.g., error, error details, current processing, etc.). For instance, an image may indicate that a GPU is not functional. In some examples, the image(s) may include platform-specific image(s) (e.g., logos, manufacturer symbols, etc.). In some examples, images may be utilized to produce an animation on a display during startup. For instance, a series of images (e.g., frames) may be accessed and/or displayed in sequence to produce an animated logo and/or video.

In some examples, an image (e.g., default image, general image, etc.) may be stored in the memory of the display device. For instance, a general startup image may be stored indicating a manufacturer, logo, business entity, etc. As used herein, the term “startup” may denote correspondence with an initial boot procedure, with activation after standby, waking from a standby mode or hibernation mode, etc.

An electronic device is a device that includes electronic circuitry (e.g., integrated circuitry, a chip(s), etc.). Examples of electronic devices may include display devices (e.g., display assembly for a laptop computer, monitor, television, display panel housing, etc.) and computing devices. A computing device is an electronic device that includes a processor (e.g., general-purpose processor, central processing unit (CPU), etc.). In some examples, a computing device includes a motherboard, memory, GPU, and/or basic input/output system (BIOS), etc. Examples of a computing device include a laptop computer body, desktop computer tower, assembly that includes a motherboard, housing including a CPU, etc. Some examples of electronic devices may utilize circuitry (e.g., controller(s) and/or processor(s), etc.) to perform an operation or operations. In some examples, electronic devices may execute instructions stored in memory to perform the operation(s). Instructions may be code and/or programming that specifies functionality or operation of the circuitry. In some examples, instructions may be stored in memory (e.g., Read-Only Memory (ROM), Erasable Programmable Read-Only Memory (EPROM), EEPROM, flash memory, random-access memory (RAM), dynamic random-access memory (DRAM), synchronous DRAM (SDRAM), magnetoresistive random-access memory (MRAM), phase-change random-access memory (PCRAM), hard disk drive (HDD), solid state drive (SSD), optical drive, etc.). In some examples, different circuitries in an electronic device may store and/or utilize separate instructions for operation.

In some examples, an electronic device may be linked to another electronic device or devices using a wired link. For example, an electronic device may include a wired communication interface for connecting electronic devices. Examples of communication interfaces may include a SPI, I2C interface, General Purpose Input/Output (GPIO) interface, Universal Serial Bus (USB) interface, etc.

In some examples, an electronic device may be linked to another electronic device with a wireless link. For instance, an electronic device (e.g., display device and/or computing device, etc.) may include a wireless communication interface to send and/or receive wireless (e.g., radio frequency (RF)) signals. Examples of wireless communication interfaces may include an Institute of Electrical and Electronics Engineers (IEEE®) 802.11 (WI-FI®) interface, Bluetooth® interface, cellular (e.g., 3G, Long-Term Evolution (LTE®), 4G, 5G, etc.) interface, etc.

Throughout the drawings, similar reference numbers may designate similar or identical elements. When an element is referred to without a reference number, this may refer to the element generally, with and/or without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

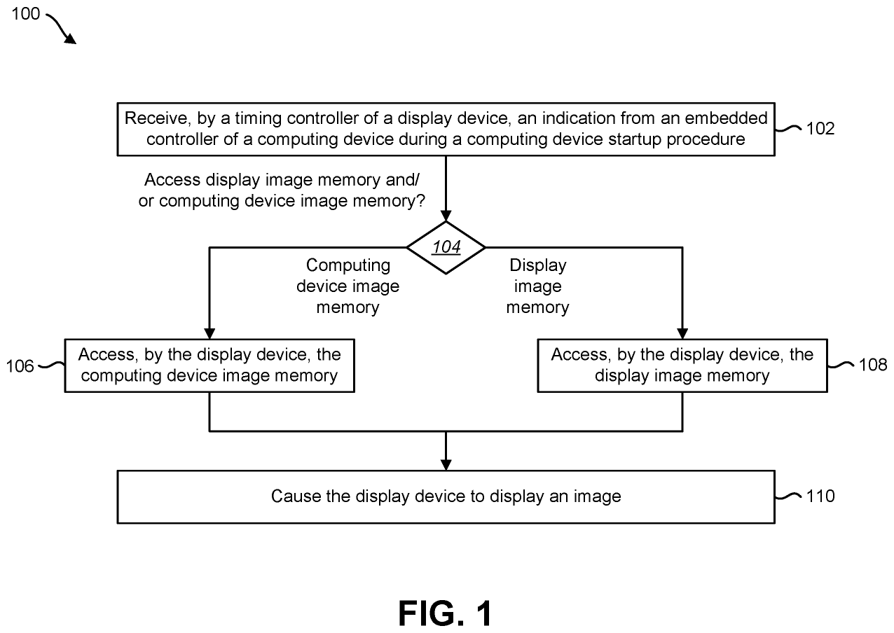

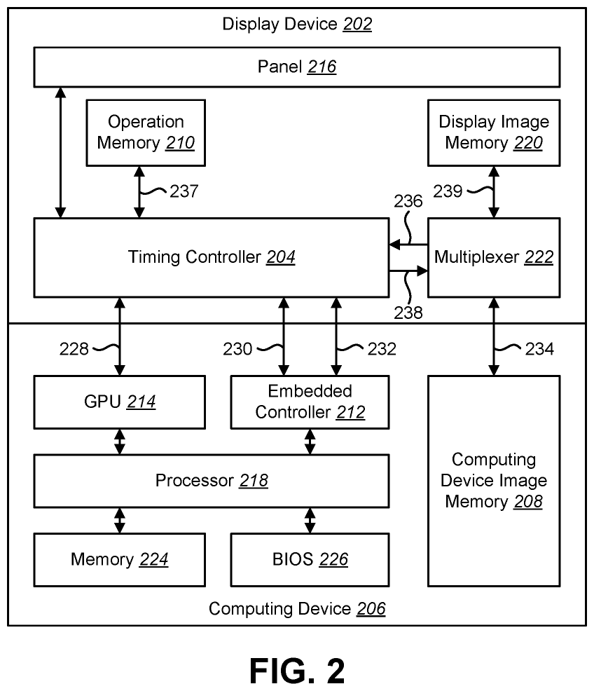

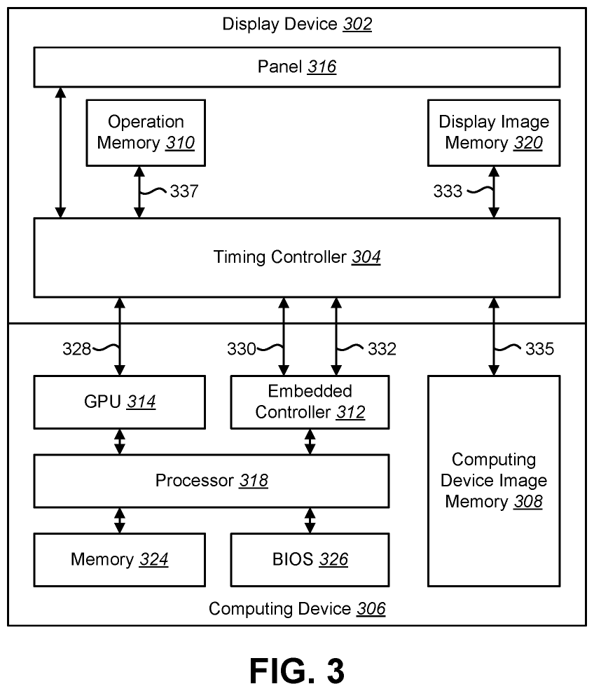

FIG. 1 is a flow diagram illustrating an example of a method 100 for memory access. The method 100 and/or a method 100 element(s) may be performed by an electronic device (e.g., a display device). For instance, the method 100 may be performed by the display device 202 described in relation to FIG. 2 and/or the display device 302 described in relation to FIG. 3. The display device may be connected to a computing device. A computing device is an electronic device that includes a processor (e.g., CPU) For instance, the display device may be connected to a motherboard (e.g., GPU, embedded controller, etc.) of a laptop computer or desktop computer. In some examples, the display device may be connected to a computing device by an interface or interfaces (e.g., SPI, I2C, GPIO, and/or other interface such as an auxiliary connection or channel). In some examples, a timing controller of the display device may be coupled to the embedded controller of the computing device via an I2C interface. For instance, the timing controller may be an I2C worker to the embedded controller (e.g., the embedded controller may supply a clock signal and/or message(s) to the timing controller).

The method 100 includes receiving 102, by a timing controller of a display device, an indication from an embedded controller of a computing device during a computing device startup procedure. An embedded controller is a circuit (e.g., integrated circuit, microcontroller, etc.) to control an aspect(s) of a computing device. In some examples, an embedded controller is distinct (e.g., different circuitry) from a processor (e.g., CPU) of a computing device. For instance, an embedded controller may perform an operation or operations that are not performed by a CPU and/or operating system (OS) of a computing device. In some examples, an embedded controller may perform an operation or operations during a startup procedure (e.g., before a CPU and/or operating system of a computing device have completed a startup procedure, and/or before a CPU and/or operating system are ready for user interaction).

In some examples, an embedded controller may be included in (e.g., may be coupled to) a motherboard of a computing device. A motherboard is a circuit board to include a computing device component or components. For instance, a motherboard may include (e.g., may be coupled to) a processor (e.g., CPU), memory (e.g., general-purpose memory, main memory, RAM, etc.), BIOS, GPU, northbridge, and/or southbridge, etc.

In some examples, the embedded controller sends the indication to the timing controller via an interface (e.g., I2C interface, SPI, GPIO interface, etc.). The indication is a signal, message, and/or information. In some examples, the indication may indicate whether to display an image from display image memory or computing device image memory. Display image memory is memory included in the display device. For instance, display image memory may be memory (e.g., flash memory, EEPROM, etc.) included in and/or coupled to a timing controller board of the display device. In some examples, display image memory may have a relatively small capacity. For instance, display image memory may have a capacity less than or equal to 128 kilobytes (kB), 256 kB, 512 kB, 1024 kB, 1.5 megabytes (MB), 2 MB, 5 MB, etc. In some examples, the display image memory may store an image or images (e.g., startup image(s)). In an example of a relatively low-resolution image with width and height of 308× 454, the image size with 4 bits of color depth is 308×454×4=559328 bits≈68 kB for storage. A higher resolution (e.g., 1080p, 4K, etc.) image and/or multiple images may occupy a significant proportion of display image memory capacity or may be too large to store in the display image memory. In some examples, display image memory may also be constrained due to storing other data (e.g., timing controller instructions, Extended Display Identification Data (EDID), etc.).

Computing device image memory is memory included in the computing device. For instance, computing device image memory may be memory (e.g., flash memory, EEPROM, etc.) included in and/or coupled to a motherboard of the computing device. In some examples, computing device image memory may have a larger capacity and/or space for image data than the display image memory. For instance, computing device image memory may have a capacity greater than 128 kB, 256 kB, 512 kB, 1024 kB, 1.5 megabytes (MB), 2 MB, 5 MB, etc. The computing device image memory may be external to the display device. For instance, the computing device image memory may be disposed in a housing other than a display device housing. In some examples, the computing device image memory is included in a motherboard that is external to the display device. In some examples, the computing device image memory is distinct from (e.g., separate from, different circuitry from) general-purpose memory (e.g., main memory, RAM, etc.) of the computing device. In some examples, general-purpose memory of the computing device may be volatile memory (e.g., RAM) and the computing device image memory may be non-volatile memory (e.g., EEPROM). In some examples, the computing device image memory may have lesser capacity than the general-purpose memory capacity (e.g., 2 gigabytes (GB), 4 GB, 8 GB, 16 GB, 32 GB, etc.) of the computing device.

In some examples, the indication from the embedded controller may be based on a setting. For instance, a setting may be established (based on user input from a manufacturer, technician, end-user, etc.) that dictates whether the embedded controller sends an indication to access computing device image memory or display image memory.

In some examples, the indication from the embedded controller may be based on a computing device status. For instance, the motherboard (e.g., via a BIOS) of the computing device may detect and/or indicate a computing device status. The computing device status may be information indicating an operation, error, and/or other condition of the computing device. For instance, the motherboard may provide a computing device status during and/or after a startup procedure. Examples of computing device status may include BIOS updating, CPU failure, memory (e.g., general-purpose memory) failure, graphics (e.g., GPU) failure, BIOS corruption, and/or battery power status (e.g., percentage of battery charge, low battery charge, etc.), etc. For instance, the motherboard (e.g., via a BIOS) may detect a component (e.g., CPU, GPU, memory, etc.) status and/or failure. In some examples, the embedded controller may receive, detect, and/or utilize the computing device status to provide an indication of the computing device status. In some examples, images corresponding to respective computing device statuses may be stored and/or displayed according to the computing device status. For instance, the indication from the embedded controller may indicate the computing device status. The indication (e.g., computing device status) may indicate a specific image and/or the timing controller may map an indication to a specific image (using a table, index, and/or address list, etc.).

In some examples, the indication may identify an image of a set of images stored in the computing device image memory. For instance, the indication may indicate a status corresponding to a specific image (e.g., BIOS updating status corresponds to an image indicating a BIOS update, GPU failure status corresponds to an image indicating GPU failure, etc.). In some examples, the indication may identify a location and/or address of an image corresponding to the status.

The method 100 includes determining 104, by the timing controller, whether to access display image memory and/or computing device image memory based on the indication. For example, the timing controller may read the indication sent from the embedded controller. The timing controller may determine to access display image memory and/or computing device image memory as specified by the indication. For instance, if the indication specifies display image memory (or does not indicate computing device image memory, for example), the timing controller may determine to access the display image memory. If the indication specifies computing device image memory, the timing controller may determine to access the computing device image memory. As described above, the indication may identify an image of a set of images stored in the computing device image memory in some approaches. In some examples, the timing controller may determine to access the computing device image memory to read the identified image.

The method 100 may include accessing 106, by the display device, the computing device image memory in response to determining to access the computing device image memory. For example, in a case that the timing controller determines to access the computing device image memory, the display device (e.g., the timing controller and/or another circuit(s) such as a multiplexer) may access 106 the computing device image memory. In some examples, accessing 106 the computing device image memory may include communicating with the computing device image memory via an interface(s) and/or may include reading (e.g., requesting and/or receiving) an image(s) from the computing device image memory.

In some examples, the timing controller may access the computing device image memory. For instance, the timing controller may be coupled to the computing device image memory via an interface (e.g., an I2C interface). In some examples, the timing controller may be an I2C manager to the computing device image memory. For instance, the timing controller may have an I2C manager role in communicating via an I2C interface with the computing device image memory, which may have an I2C worker role. In some examples, an I2C manager may supply a clock signal and/or may send a request(s) to an I2C worker, which may respond to the request(s). For example, the timing controller may issue a request for an image(s) from the computing device image memory via the I2C interface. The computing device image memory may send the image(s) to the timing controller. An example of the timing controller accessing the computing device image memory is given in relation to FIG. 3.

In some examples, the display device may include a multiplexer. The timing controller may utilize the multiplexer to access the computing device image memory. For instance, the timing controller may be coupled to the multiplexer. In some examples, the timing controller may be coupled to the multiplexer via a GPIO interface. In some examples, the method 100 includes sending, by the timing controller, a control signal to the multiplexer of the display device to select the computing device image memory in response to determining to access the computing device memory. For instance, the control signal may switch the multiplexer between the computing device image memory and the display image memory. In some examples, the multiplexer is coupled to the timing controller via an SPI interface, to the display image memory via an SPI interface, and/or to the computing device image memory via an SPI interface. In some examples, the timing controller may send the control signal to the multiplexer via a GPIO interface.

The timing controller and/or the multiplexer may access the computing device image memory via an interface(s) (e.g., SPI(s)). For example, the multiplexer may request and/or receive an image(s) from the computing device image memory via an interface. The computing device image memory may send the image(s) to the multiplexer. The multiplexer may send (e.g., route) the image(s) to the timing controller via an interface. An example of the timing controller accessing the computing device image memory via a multiplexer is given in relation to FIG. 2.

In some examples, the method 100 includes selecting an image from a set of images in the computing device image memory based on the indication. For instance, respective images of the set of images may correspond to respective computing device statuses (as described above). In some examples, the respective images may include a BIOS update image, a processor failure image, a memory failure image, a graphics (e.g., GPU) failure image, a BIOS corruption image, a low battery image, a logo image (e.g., fast start manufacturer logo), and/or a security activation image, etc. In some examples, the timing controller and/or multiplexer may send a request(s) that identify an image(s) of a set of images stored in the computing device image memory.

In some examples, the method 100 includes accessing 108, by the display device, the display image memory in response to determining to access display image memory. For instance, the timing controller and/or a multiplexer may access the display image memory via an interface(s). In some examples, the timing controller may access the display image memory via an interface (e.g., SPI interface). The timing controller may read (e.g., request and/or receive) an image from the display image memory. In some examples, the timing controller may send a control signal to a multiplexer (via a GPIO interface, for instance). The multiplexer may access the display image memory via an interface (e.g., SPI interface). The multiplexer may read (e.g., send a request and/or receive) an image from the display image memory. The multiplexer may send (e.g., route) the image to the timing controller.

In some examples, the timing controller may determine 104 to access both the computing device image memory and the display image memory. For instance, the display image memory may be accessed to display an image in display image memory and then the computing device image memory may be accessed to display an image from the computing device image memory. In some examples, the indication may indicate to access both the computing device image memory and the display image memory. An image from the computing device image memory and the display image memory may be displayed in sequence and/or concurrently. For instance, the timing controller may load an image from the computing device image memory into a first subset of a frame buffer and may load an image from the display image memory into a second subset of the frame buffer for concurrent display.

The method 100 may include causing 110 the display device to display an image. For example, the timing controller may provide an image(s) from computing device image memory or from display image memory to a panel for display. In some examples, the display image memory stores an image (e.g., default image, second image, etc.), and the image from the computing device image memory is a replacement image that is displayed instead of the image from the display image memory. For instance, the method 100 may include causing 110 the display device to display an image from the computing device image memory in response to determining to access the computing device image memory.

FIG. 2 is a block diagram of an example of a display device 202 that may be used to perform memory access. The display device 202 may be an example of the display device(s) described in relation to FIG. 1. In some examples, the display device 202 may perform a method or methods (e.g., method 100) and/or an operation or operations described herein. The display device 202 may be connected to and/or linked to a computing device 206 in some examples. The computing device 206 may be an example of the computing device(s) described in relation to FIG. 1.

A computing device may be linked to a display device with a wired and/or wireless link or links. In some examples, a link may be a wire, trace, bus, and/or connector, etc. In the example of FIG. 2, a first link 228, a second link 230, a third link 232, and a fourth link 234 are illustrated. In some examples, a wired link (e.g., cable) may include multiple wires and/or pins. A link may provide a channel or channels (e.g., data link, auxiliary channel, etc.) for communication. A channel may be a physical channel (e.g., wire) and/or a logical channel (e.g., frequency domain and/or time domain resources, multiplexed channel, etc.). More or fewer channels, links, and/or cables may be used in some examples. A channel may be utilized to carry a signal(s), data, etc., for an interface or interfaces. In some examples, the first link 228 may be an auxiliary link and/or channel, the second link 230 may be utilized for a GPIO interface, the third link 232 may be utilized for an I2C interface, and/or the fourth link 234 may be utilized for a SPI. In some examples, the first link 228, second link 230, third link 232, and/or fourth link 234 may traverse a separation(s), gap(s), hinge(s), boundary(ies), housing wall(s), etc., between the display device 202 and the computing device 206.

The display device 202 may include a panel 216, a timing controller 204, operation memory 210, display image memory 220, and/or a multiplexer 222. The components described in relation to FIG. 2 may be examples of corresponding components described in relation to FIG. 1. In some examples, the timing controller 204, the operation memory 210, the display image memory 220, and the multiplexer 222 are included in a timing controller board.

The timing controller 204 may be coupled to the panel 216, operation memory 210, and/or the multiplexer 222 included in the display device 202. For instance, the timing controller 204 may be directly coupled or indirectly coupled (through intervening circuitry, for instance) to the panel 216, operation memory 210, and/or the multiplexer 222. The multiplexer 222 may be coupled to the display image memory 220. The timing controller 204 may be coupled to the display image memory 220 through the multiplexer 222.

The panel 216 is circuitry to display optical information. Examples of the panel 216 may include a light-emitting diode (LED) liquid crystal display (LCD) panel, microLED panel, miniLED panel, and/or organic light-emitting diode (OLED) panel, etc. The panel 216 may display an image(s) (e.g., still image(s), video(s), animation(s), etc.). For example, some display devices may include an LCD cell layer and an LED backlight layer. An image may be produced by emitting light from the LED backlight layer through colors exhibited by the LCD cell layer.

In some examples, the timing controller 204 is coupled to the operation memory 237 via a first internal link 237. In some examples, the first internal link 237 may be utilized for an I2C interface or another interface. The operation memory 210 may be a device (e.g., circuitry) to store information. In some examples, the operation memory 210 is EEPROM. In some examples, the operation memory 210 may store EDID, timing controller instructions, and/or other data. For instance, the timing controller 204 may access the operation memory 210 through the first internal link 237, may execute timing controller instructions from the operation memory 210, and/or may read and/or write other data (e.g., EDID) in the operation memory 210.

In some examples, the timing controller 204 is coupled to the multiplexer 222 with a second internal link 236 and/or a third internal link 238. In some examples, the second internal link 236 may be utilized for a SPI or another interface. In some examples, the third internal link 238 may be utilized for a GPIO interface or another interface.

In some examples, the multiplexer 222 is coupled to the display image memory 220 with a fourth internal link 239. In some examples, the fourth internal link 239 may be utilized for a SPI or another interface. The display image memory 220 may store an image(s) (e.g., startup image(s), logo(s), etc.). In some examples, the display image memory may be flash memory.

The computing device 206 may include a GPU 214, embedded controller 212, processor 218, memory 224, BIOS 226, and/or computing device image memory 208. In some examples, the GPU 214, embedded controller 212, processor 218, memory 224, BIOS 226, and/or computing device image memory 208 may be coupled to (e.g., integrated in) a motherboard of the computing device 206. A component or components of the computing device 206 may be an example(s) of a corresponding component or components described in relation to FIG. 1. For example, the processor 218 may be a CPU. In some examples, the memory 224 (e.g., RAM) and/or the GPU 214 may be coupled to the processor 218 via a northbridge and/or a Peripheral Component Interconnect Express (PCI Express®) bridge. In some examples, the embedded controller 212 and/or the BIOS 226 may be coupled to the processor 218 via a southbridge. In some examples, the GPU 214 may be coupled to the timing controller 204 via the first link 228, the embedded controller 212 may be coupled to the timing controller 204 via the second link 230 and the third link 232, and/or the computing device image memory 208 may be coupled to the multiplexer 222 via the fourth link 234. In some examples, the computing device 206 may include a link (not shown in FIG. 2) to the computing device image memory 208 for loading an image(s) on the computing device image memory 208 (from the processor 218, embedded controller 212, and/or another interface, for instance).

The computing device image memory 208 may store an image(s). In some examples, the images may include a BIOS update image, a processor failure image, a memory failure image, a graphics (e.g., GPU) failure image, a BIOS corruption image, a low battery image, a logo image (e.g., fast start manufacturer logo), and/or a security activation image, etc. In some examples, the image(s) may include a compilation of images. For instance, a compilation of images may be a logo splash image in combination with one of various messages.

In some examples, the timing controller 204 may control selection of a group including internal memory (e.g., display image memory 220) and external memory (e.g., computing device image memory 208). For instance, the timing controller 204 may select the internal memory (e.g., display image memory 220) or the external memory (e.g., computing device image memory 208) in response to an indication from the computing device 206. In some examples, the multiplexer 222 may switch between the internal memory (e.g., display image memory 220) and the external memory (e.g., computing device image memory 208) based on a selection signal from the timing controller 204. For instance, the timing controller 204 may send a selection signal to the multiplexer 222 via the third internal link 238 (e.g., GPIO interface). The multiplexer 222 may provide an image(s) from the display image memory 220 or from the computing device image memory 208 based on the selection signal. For instance, the multiplexer 222 may provide an image(s) from the display image memory 220 via the fourth internal link 239 and the second internal link 236 (e.g., SPI) to the timing controller 204 if the display image memory 220 is selected. The multiplexer 22 may provide an image(s) from the computing device image memory 208 via the fourth link 234 and the second internal link 236 (e.g., SPI) to the timing controller 204 if the computing device image memory 208 is selected. The panel 216 may display an image from the internal memory (e.g., display image memory 220) or the external memory (e.g., computing device image memory 208) in response to the indication from the computing device 206.

A more specific example of memory access in accordance with some of the techniques described herein is given as follows. Upon power-up (e.g., when the display device 202 receives power), the panel 216 may receive a voltage to power the panel. In some examples, the display device 202 and/or the computing device 206 may perform link training to set up a link(s) for transferring image data. In some examples, a backlight may be enabled (to provide backlight for the panel 216, for instance). The embedded controller 212 may send an indication (e.g., an I2C command) indicating a target data source (e.g., the display image memory 220 or the computing device image memory 208). For instance, an I2C command structure may be customized to add a new message to cause the timing controller 204 to determine an image source (e.g., SPI source from the display device 202 or a motherboard of the computing device 206). Based on the indication, the timing controller 204 may send the control signal to the multiplexer 222. For instance, the timing controller 204 may set a GPIO interface signal low (e.g., digital low) to control the multiplexer 222 to access the display image memory 220 (e.g., internal SPI flash) or may set the GPIO interface signal high (e.g., digital high) to control the multiplexer to access the computing device image memory 208 (e.g., external SPI EEPROM). The timing controller 204 receives the image(s) (via SPI bus, for instance) and provides the image(s) to the panel 216 for display. The display device 202 may discontinue display the image(s) (after a period of time and/or upon detection of an event, for instance).

FIG. 3 is a block diagram of an example of a display device 302 that may be used to perform memory access. The display device 302 may be an example of the display device(s) described in relation to FIG. 1 and/or FIG. 2. In some examples, the display device 302 may perform a method or methods (e.g., method 100) and/or an operation or operations described herein. The display device 302 may be connected to and/or linked to a computing device 306 in some examples. The computing device 306 may be an example of the computing device(s) described in relation to FIG. 1.

In the example of FIG. 3, a first link 328, a second link 330, a third link 332, and a fourth link 335 are illustrated. In some examples, a wired link (e.g., cable) may include multiple wires and/or pins. More or fewer channels, links, and/or cables may be used in some examples. In some examples, the first link 328 may be an auxiliary link and/or channel, the second link 330 may be utilized for a GPIO interface, the third link 332 may be utilized for an I2C interface, and/or the fourth link 335 may be utilized for an I2C interface (e.g., a second I2C interface). In some examples, the first link 328, second link 330, third link 332, and/or fourth link 335 may traverse a separation(s), gap(s), hinge(s), boundary(ies), housing wall(s), etc., between the display device 302 and the computing device 306.

The display device 302 may include a panel 316, a timing controller 304, operation memory 310, and/or display image memory 320. The components described in relation to FIG. 3 may be examples of corresponding components described in relation to FIG. 1 and/or FIG. 2. In some examples, the timing controller 304, the operation memory 310, and the display image memory 320 are included in a timing controller board.

The timing controller 304 may be coupled to the panel 316, operation memory 310, and/or the display image memory 320 included in the display device 302. For instance, the timing controller 304 may be directly coupled or indirectly coupled (through intervening circuitry, for instance) to the panel 316, operation memory 310, and/or the display image memory 320.

The panel 316 is circuitry to display optical information. The panel 316 may display an image(s) (e.g., still image(s), video(s), animation(s), etc.).

In some examples, the timing controller 304 is coupled to the operation memory 337 via a first internal link 337. In some examples, the first internal link 337 may be utilized for an I2C interface or another interface. The operation memory 310 may be a device (e.g., circuitry) to store information. In some examples, the operation memory 310 is EEPROM. In some examples, the operation memory 310 may store EDID, timing controller instructions, and/or other data. For instance, the timing controller 304 may access the operation memory 310 through the first internal link 337, may execute timing controller instructions from the operation memory 310, and/or may read and/or write other data (e.g., EDID) in the operation memory 310.

In some examples, the timing controller 304 is coupled to the display image memory 320 with a second internal link 333. In some examples, the second internal link 333 may be utilized for a SPI or another interface. The display image memory 320 may store an image(s) (e.g., startup image(s), logo(s), etc.). In some examples, the display image memory may be flash memory.

The computing device 306 may include a GPU 314, embedded controller 312, processor 318, memory 324, BIOS 326, and/or computing device image memory 308. In some examples, the GPU 314, embedded controller 312, processor 318, memory 324, BIOS 326, and/or computing device image memory 308 may be included in (e.g., coupled to) a motherboard of the computing device 306. A component or components of the computing device 306 may be an example(s) of a corresponding component or components described in relation to FIG. 1. For example, the processor 318 may be a CPU. In some examples, the memory 324 (e.g., RAM) and/or the GPU 314 may be coupled to the processor 318 via a northbridge and/or a PCI Express® bridge. In some examples, the embedded controller 312 and/or the BIOS 326 may be coupled to the processor 318 via a southbridge. In some examples, the GPU 314 may be coupled to the timing controller 304 via the first link 328, the embedded controller 312 may be coupled to the timing controller 304 via the second link 330 and the third link 332, and/or the computing device image memory 308 may be coupled to the display image memory 320 via the fourth link 335. In some examples, the computing device 306 may include a link (not shown in FIG. 3) to the computing device image memory 308 for loading an image(s) on the computing device image memory 308 (from the processor 318, embedded controller 312, and/or another interface, for instance).

The computing device image memory 308 may store an image(s). In some examples, the images may include a BIOS update image, a processor failure image, a memory failure image, a graphics (e.g., GPU) failure image, a BIOS corruption image, a low battery image, a logo image (e.g., fast start manufacturer logo), and/or a security activation image, etc.

In some examples, the timing controller 304 may control selection of a group including internal memory (e.g., display image memory 320) and external memory (e.g., computing device image memory 308). For instance, the timing controller 304 may select the internal memory (e.g., display image memory 320) or the external memory (e.g., computing device image memory 308) in response to an indication from the computing device 306. In some examples, timing controller 304 may select between the internal memory (e.g., display image memory 320) and the external memory (e.g., computing device image memory 308) based on an indication from the embedded controller 312. The timing controller 304 may access the internal memory (e.g., display image memory 320) or external memory (e.g., computing device image memory 308). The display image memory 320 may provide an image(s) from the display image memory 320 or from the computing device image memory 308 based on the indication. For instance, the timing controller 304 may receive the indication from the computing device 306 in an I2C interface worker role (via the third link 332 where the embedded controller 312 is an I2C manager, for instance) and may access the external memory (e.g., computing device image memory 308) in an I2C manager role (via the fourth link 335 where the computing device image memory 308 is an I2C worker, for instance). In some examples, the display image memory 320 may provide an image(s) from the display image memory 320 via the second internal link 333 (e.g., SPI) to the timing controller 304 if the display image memory 320 is selected. The computing device image memory 308 may provide an image(s) from the computing device image memory 208 via the fourth link 335 (e.g., I2C) to the timing controller 304 if the computing device image memory 308 is selected. The panel 316 may display an image from the internal memory (e.g., display image memory 320) or the external memory (e.g., computing device image memory 308) in response to the indication from the computing device 306.

A more specific example of memory access in accordance with some of the techniques described herein is given as follows. Upon power-up (e.g., when the display device 302 receives power), the panel 316 may receive a voltage to power the panel. In some examples, the display device 302 and/or the computing device 306 may perform link training to set up a link(s) for transferring image data. In some examples, a backlight may be enabled (to provide backlight for the panel 316, for instance). The embedded controller 312 may send an indication (e.g., an I2C command) indicating a target data source (e.g., the display image memory 320 or the computing device image memory 308). For instance, an I2C command structure may be customized to add a new message to cause the timing controller 304 to determine an image source (e.g., SPI source from the display device 302 or an I2C source of the computing device 306). Based on the indication, the timing controller 304 may access the display image memory 320 (e.g., internal SPI flash) or may access the computing device image memory 308 (e.g., external SPI EEPROM). For instance, the timing controller 304 may drive a clock signal (e.g., I2C clock signal) to the display image memory 320 or may drive a clock signal (e.g., I2C clock signal) to the computing device image memory 308 based on the indication. In some examples, the timing controller 304 (as an I2C manager) may initiate a transfer from the computing device image memory 308 (as an I2C worker) over an I2C bus. The timing controller 304 receives the image(s) (via an I2C serial data line (SDA) signal, for instance) and provides the image(s) to the panel 316 for display. The display device 302 may discontinue display the image(s) (after a period of time and/or upon detection of an event, for instance).

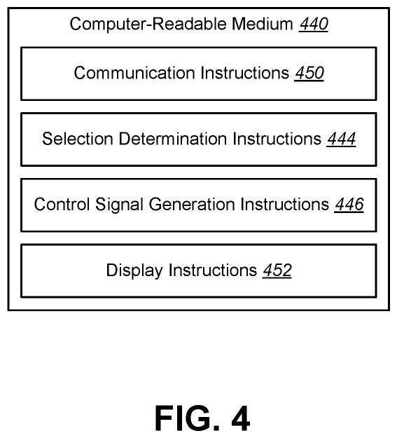

FIG. 4 is a block diagram illustrating an example of a computer-readable medium 440 for memory access. The computer-readable medium 440 may be a non-transitory, tangible computer-readable medium. The computer-readable medium 440 may be, for example, RAM, EEPROM, a storage device, an optical disc, and/or the like. In some examples, the computer-readable medium 440 may be volatile and/or non-volatile memory, such as DRAM, EEPROM, MRAM, PCRAM, memristor, flash memory, and/or the like. In some examples, the computer-readable medium 440 may be included in a display device and/or may be accessible to a timing controller of a display device. In some examples, the computer-readable medium 440 may be an example of the operation memory 210 and/or operation memory 310 described in relation to FIG. 2 and/or FIG. 3.

The computer-readable medium 440 may include data (e.g., information and/or executable instructions, etc.). For example, the computer-readable medium 440 may include communication instructions 450, selection determination instructions 444, control signal determination instructions 446, and/or display instructions 452.

In some examples, the communication instructions 450 are instructions, when executed, cause a timing controller to receive an indication from an embedded controller of a computing device via an I2C interface. In some examples, the indication may be received as described in relation to FIG. 1, FIG. 2, and/or FIG. 3. In some examples, the timing controller may execute the communication instructions 450 to send and/or receive another signal or signals described herein.

In some examples, the selection determination instructions 444 are instructions, when executed, cause a timing controller to determine, based on the indication, a selection of a group including external image memory that is external to a display device and internal image memory that is internal to the display device. In some examples, determining the selection may be performed as described in relation to FIG. 1, FIG. 2, and/or FIG. 3.

In some examples, the control signal determination instructions 446 are instructions, when executed, cause a timing controller to generate a control signal based on the selection. In some examples, the control signal is an I2C interface signal. For instance, the timing controller may generate a clock signal and send the clock signal to internal image memory or external image memory based on the selection. In some examples, the control signal is a GPIO interface signal. For instance, the timing controller may generate a control signal (e.g., digital high or low) and send the control signal to a multiplexer to select internal image memory or external image memory. In some examples, generating the control signal may be performed as described in relation to FIG. 1, FIG. 2, and/or FIG. 3.

In some examples, the display instructions 452 are instructions, when executed, cause a timing controller to send an image to a display panel based on the control signal. In some examples, sending the image to a display panel may be performed as described in relation to FIG. 1, FIG. 2, and/or FIG. 3.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be within the scope of the disclosure. For example, aspects or elements of the examples described herein may be omitted or combined.

What is claimed is:

1. A method, comprising:
receiving, by a timing controller of a display device, an indication from an embedded controller of a computing device during a computing device startup procedure;
determining, by the timing controller, whether to access display image memory or computing device image memory based on the indication;
accessing, by the display device, the computing device image memory in response to determining to access the computing device image memory; and
causing the display device to display an image from the computing device image memory in response to determining to access the computing device image memory.

2. The method of claim 1, further comprising selecting the image from a set of images in the computing device image memory based on the indication.

3. The method of claim 2, wherein respective images of the set of images correspond to respective computing device statuses.

4. The method of claim 3, wherein the respective images comprise a basic input/output system (BIOS) update image, a processor failure image, a memory failure image, a graphics failure image, a BIOS corruption image, and a low battery image.

5. The method of claim 1, wherein the timing controller is an Inter-Integrated Circuit (I2C) worker to the embedded controller, and wherein the timing controller is an I2C manager to the computing device image memory.

6. The method of claim 1, further comprising sending, by the timing controller, a control signal to a multiplexer of the display device to select the computing device image memory in response to determining to access the computing device image memory.

7. The method of claim 6, wherein the timing controller sends the control signal to the multiplexer via a General Purpose Input/Output (GPIO) interface.

8. The method of claim 1, wherein the display image memory stores a second image, and wherein the image from the computing device image memory is a replacement image displayed instead of the second image.

9. The method of claim 1, wherein the computing device image memory is included in a motherboard that is external to the display device.

10. A display device, comprising:
display image memory to store a startup image;
a timing controller to control selection of a group including display image memory and external memory, and to select the external memory in response to an indication from a computing device; and
a panel to display an image from the external memory in response to the indication from the computing device.

11. The display device of claim 10, wherein the timing controller is to:
receive the indication from the computing device in an Inter-Integrated Circuit (I2C) interface worker role; and
access the external memory in an I2C manager role.

12. The display device of claim 10, further comprising a multiplexer coupled to the timing controller, the multiplexer to switch between the display image memory and the external memory based on a selection signal from the timing controller.

13. A non-transitory tangible computer-readable medium comprising instructions when executed cause a timing controller to:
receive an indication from an embedded controller of a computing device via an Inter-Integrated Circuit (I2C) interface;
determine, based on the indication, a selection of a group including external image memory that is external to a display device and internal image memory that is internal to the display device;
generate a control signal based on the selection; and
send an image to a display panel based on the control signal.

14. The non-transitory tangible computer-readable medium of claim 13, wherein the control signal is an I2C interface signal.

15. The non-transitory tangible computer-readable medium of claim 13, wherein the control signal is a General Purpose Input/Output (GPIO) interface signal.
